(19) United States
(12) Patent Application Publication
(10) Pub. No.: US 2008/0252654 A1
(43) Pub. Date: Oct. 16, 2008

(54) DISPLAY CONTROL CIRCUIT AND DISPLAY DEVICE

(75) Inventor: Kiyoshi Hidaka, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (DD)

(21) Appl. No.: 12/099,857

(22) Filed: Apr. 9, 2008

(30) Foreign Application Priority Data
Apr. 13, 2007 (JP) 2007-105698

(51) Int. Cl. G09G 5/02

(52) U.S. Cl. 345/593

(57) ABSTRACT

A display control circuit has a memory configured to store three-colors pixel data, a first selector configured to select one color pixel data for m pixels in order among the three-colors pixel data for the m pixels read out from the memory when performing vertically long display in a display panel, where m is an integer of 1 or more, and to select one color pixel data for n pixels in order among the three-colors pixel data for the n pixels read out from the memory when performing horizontally long display in a display panel, where n is an integer of 1 or more, and different from m, a second selector configured to select pixel data for one pixel in order among the pixel data for m pixels selected by the first selector when performing the vertically long display, and to select pixel data for one pixel in order among the pixel data for n pixels selected by the first selector when performing the horizontally long display, a D/A converter configured to convert the pixel data selected by the second selector into an analog pixel voltage, and a write controller configured to perform control for storing three-colors pixel data having the number of bits different between the vertically long display and the horizontally long display into the memory.

### CROSS REFERENCE TO RELATED APPLICATIONS

This application is based upon claims the benefit of priority from the prior Japanese Patent Application No. 2007-105698, filed on Apr. 13, 2007, the entire contents of which are incorporated herein by reference.

### BACKGROUND OF THE INVENTION

1. Field of the Invention

The present invention relates to a display control circuit for driving a display panel and a display device having this display control circuit.

2. Related Art

A vertically long liquid crystal panel has been conventionally used in a mobile telephone. A liquid crystal display driver with an embedded RAM (hereinafter, an LCD driver) is disposed in the vicinity of the upper or lower end of the liquid crystal panel of this kind. The conventional LCD driver has been designed to perform vertically long display in the liquid crystal panel, but has not intended to perform horizontally long display such as a TV screen (refer to JP-A 2006-208998 (Kokai)).

The following three methods are conceived as ways to perform the horizontally long display in the liquid crystal panel:

(1) The liquid crystal panel is horizontally disposed without changing the arrangement of the LCD driver, and the direction in which data is written into a display memory is changed from the horizontal direction to the vertical direction.

(2) The short sides of the liquid crystal panel are used as long sides for the horizontally long display, so that the horizontally long display is performed using a portion of the display area of the vertically long liquid crystal panel.

(3) An LCD driver for driving a liquid crystal panel for the horizontally long display is newly developed.

However, in the case of (1), it is not easy to write a plurality of pixel data collectively into the display memory. In the case of (2), the whole display area of the screen can not be used in the horizontally long display, thereby degrading display resolution. In the case of (3), the development cost increases, and it takes too much time to develop the liquid display, thereby increasing demerit.

### SUMMARY OF THE INVENTION

According to one aspect of the present invention, a display control circuit, comprising:

a memory configured to store three-colors pixel data;

a first selector configured to select one color pixel data for m pixels in order among the three-colors pixel data for the m pixels read out from the memory when performing vertically long display in a display panel, where m is an integer of 1 or more, and to select one color pixel data for n pixels in order among the three-colors pixel data for the n pixels read out from the memory when performing horizontally long display in a display panel, where n is an integer of 1 or more, and different from m;

a second selector configured to select pixel data for one pixel in order among the pixel data for m pixels selected by the first selector when performing the vertically long display, and to select pixel data for one pixel in order among the pixel data for n pixels selected by the first selector when performing the horizontally long display;

a D/A converter configured to convert the pixel data selected by the second selector into an analog pixel voltage; and

a write controller configured to perform control for storing three-colors pixel data having the number of bits different between the vertically long display and the horizontally long display into the memory.

According to one aspect of the present invention, a display apparatus, comprising:

a display panel having a plurality of pixel switches which are provided to correspond to each cross point of signal lines and scanning lines arranged in matrix form; and

a display control circuit configured to generate analog pixel voltages supplied to the plurality of pixel switches,

wherein the display control circuit includes:

a memory configured to store three-colors pixel data;

a first selector configured to select one color pixel data for m pixels in order among the three-colors pixel data for the m pixels read out from the memory when performing vertically long display in a display panel, where m is an integer of 1 or more, and to select one color pixel data for n pixels in order among the three-colors pixel data for the n pixels read out from the memory when performing horizontally long display in a display panel, where n is an integer of 1 or more, and different from m;

a second selector configured to select pixel data for one pixel in order among the pixel data for m pixels selected by the first selector when performing the vertically long display, and to select pixel data for one pixel in order among the pixel data for n pixels selected by the first selector when performing the horizontally long display;

a D/A converter configured to convert the pixel data selected by the second selector into an analog pixel voltage; and

a write controller configured to perform control for storing three-colors pixel data having the number of bits different between the vertically long display and the horizontally long display into the memory.

### BRIEF DESCRIPTION OF THE DRAWINGS

FIG. 1A is a diagram showing RGB pixel data for three pixels in which each color of RGB has 8 bits, and FIG. 1B is a diagram showing RGB pixel data for four pixels in which each color of RGB has 6 bits;

FIG. 2A is a diagram showing a storage area of a memory having a data capacity which enables display in a display panel for vertically long display of vertical 320×horizontal 240 dots, and FIG. 2B is a diagram showing a storage area in the case where a memory compatible with the display panel for the vertically long display is used to store pixel data for driving a display panel for horizontally long display;

FIG. 3 is a block diagram showing the schematic configuration of a display device according to a first embodiment of the present invention;

FIG. 4 is a circuit diagram showing one example of the internal configurations of a first selector 11 and a second selector 12;

FIG. 5 is a diagram showing one example of a storage area of a RAM 6;

FIG. 6 is an operation timing diagram of an LCD driver 2 in FIG. 3;

FIG. 7 is a block diagram showing the schematic configuration of a display device according to a second embodiment of the present invention; and

FIG. 8 is an operation timing diagram of an LCD driver 2 in FIG. 7.

### DETAILED DESCRIPTION OF THE INVENTION

Hereinafter, embodiments of the present invention will be described with reference to the drawings.

(Fundamental Principle of the Present Invention)

The present invention is characterized in that a common display control circuit can be used to drive a display panel for vertically long display and a display panel for horizontally long display.

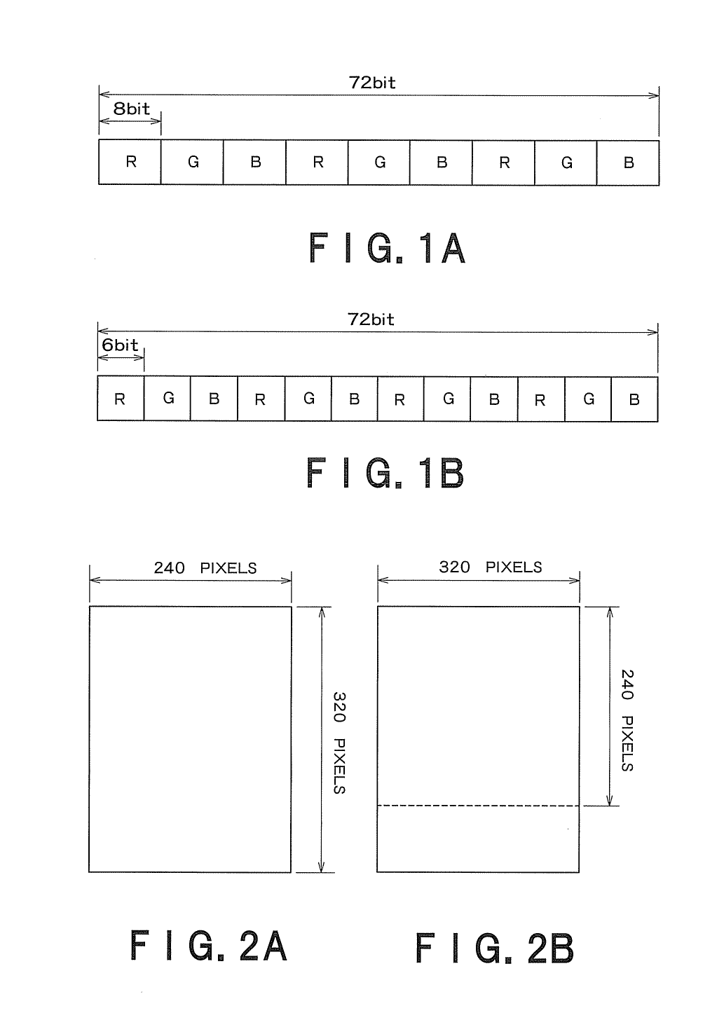

FIG. 1A shows RGB pixel data for three pixels in which each color of RGB has 8 bits (8×3×3=72 bits in total). Such pixel data is stored in a memory for one frame for the vertically long display. On the other hand, FIG. 1B shows RGB pixel data for four pixels in which each color of RGB has 6 bits (6×3×4=72 bits in total).

The total number of bits for three pixels in FIG. 1A and the total number of bits for four pixels in FIG. 1B are both 72 bits.

When display control of the display panel is performed, pixel data for one horizontal line is generally stored in the memory, and the pixel data is then read from the memory per horizontal line and supplied to the display panel.

FIG. 2A is a diagram showing a storage area of a memory having a data capacity capable of being displayed in the display panel for the vertically long display of vertical 320×horizontal 240 dots. Data for one horizontal line of the display panel (pixel data for 240 pixels including 24 bits in each pixel) is stored in one row (one read unit) of the memory. In this case, when, for example, pixel data including 18 bits in each pixel is stored in the memory, pixel data for 320 pixels can be stored in one row of the memory.

Thus, when a display panel for horizontally long display of vertical 240×horizontal 320 dots is driven, the number of bits in the pixel data is changed from 24 bits to 18 bits, so that pixel data for one horizontal line (for 320 pixels) of the display panel can be stored in one row of the memory. In this case, as shown in FIG. 2B, 240/320=3/4 of the storage area of the memory compatible with the display panel for the vertically long display is used to store pixel data for driving the display panel for the horizontally long display.

Thus, the number of bits in the pixel data to be stored in the memory is changed in accordance with the aspect ratios of the display panel for the vertically long display and the display panel for the horizontally long display, such that the same memory and display control circuit can be used to drive both the display panels for the vertically long display and the horizontally long display without changing the order of being written into the memory.

The present invention is directed its attention to this point, and the number of bits in the pixel data to be stored in the memory is changed in accordance with the aspect ratio of the display panel depending on whether the display panel for the vertically long display is driven or the display panel for the horizontally long display is driven, such that the display panel is driven with the same order of writing/reading the pixel data into/from the memory regardless of which display panel is to be driven.

Hereinafter, specific embodiments of the present invention will be described.

### FIRST EMBODIMENT

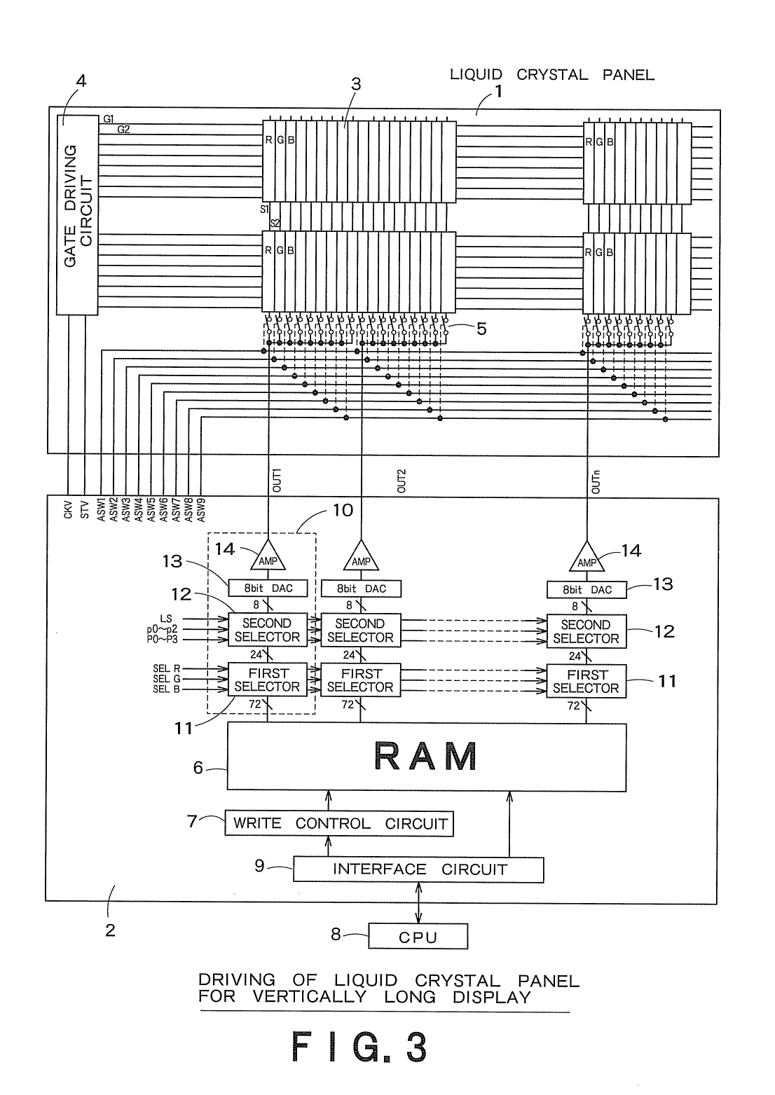

FIG. 3 is a block diagram showing a schematic configuration of a display device according to a first embodiment of the present invention.

This display device performs vertically long display, and has a liquid crystal panel 1, and an LCD driver 2 for supplying the liquid crystal panel 1 with an analog pixel voltage.

The liquid crystal panel 1 has a plurality of pixel switches 3 provided to correspond to intersections of signal lines and scan lines vertically and horizontally provided in rows, a gate driving circuit 4 for driving the scan lines, and a plurality of analog switches 5 for switching on or off the supply of the analog pixel voltage to the signal lines.

Although the display resolution of the liquid crystal panel 1 is not limited in particular, an example described below uses a liquid crystal panel 1 for vertically long display having a display resolution of vertical 320×horizontal 240 dots.

While the LCD driver 2 can drive both a liquid crystal panel 1 for vertically long display and a liquid crystal panel 1 for horizontally long display, the first embodiment shows an example of driving the liquid crystal panel 1 for the vertically long display.

The LCD driver 2 has a RAM (memory) 6 for storing RGB pixel data, a write control circuit 7 for controlling write into the RAM 6, an interface circuit 9 for receiving the RGB pixel data and so on from a host computer (CPU) 8, and a plurality of pixel voltage supply units 10.

RGB pixel data of, for example, 24-bit colors (each color having 8 bits) is stored in the RAM 6. A plurality of pixel voltage supply units 10 are provided, for example, in a ratio of one unit to three pixels. Each of the plurality of pixel voltage supply units 10 has a first selector (first selector) 11, a second selector (second selector) 12, a D/A converter (DAC) 13, and an amplifier (AMP) 14.

RGB pixel data for three pixels read from the RAM 6 is supplied to the first selector 11. The first selector 11 sequentially selects pixel data for one color of RGB out of the input RGB pixel data for three pixels (24×3=72 bits).

The second selector 12 sequentially selects pixel data for one pixel out of the pixel data of the particular color among three pixels selected by the first selector 11.

The D/A converter 13 converts the pixel data selected by the second selector 12 into an analog pixel voltage and supplies the selected analog pixel voltage to the amplifier 14. The amplifier 14 adjusts the gain of the analog pixel voltage and then supplies the analog pixel voltage to the liquid crystal panel 1.

The analog pixel voltage supplied from the LCD driver 2 to the liquid crystal panel 1 is supplied to a corresponding signal line via the analog switch 5.

Nine analog switches 5 are provided for each of the pixel voltage supply units 10. Each of these analog switches 5 is connected to the pixel switches 3 for three pixels of three colors (nine pixels in total). The analog switches 5 are switched on/off by control signals ASW1 to ASW9 supplied from the LCD driver 2.

As each of the pixel voltage supply units 10 supplies analog pixel voltages for three pixels of three colors (nine pixels in total), a total of 80 pixel voltage supply units 10 are necessary if the number of pixels in the vertical direction is 240. The RGB pixel data is supplied to each of the pixel voltage supply units 10 from the RAM 6.

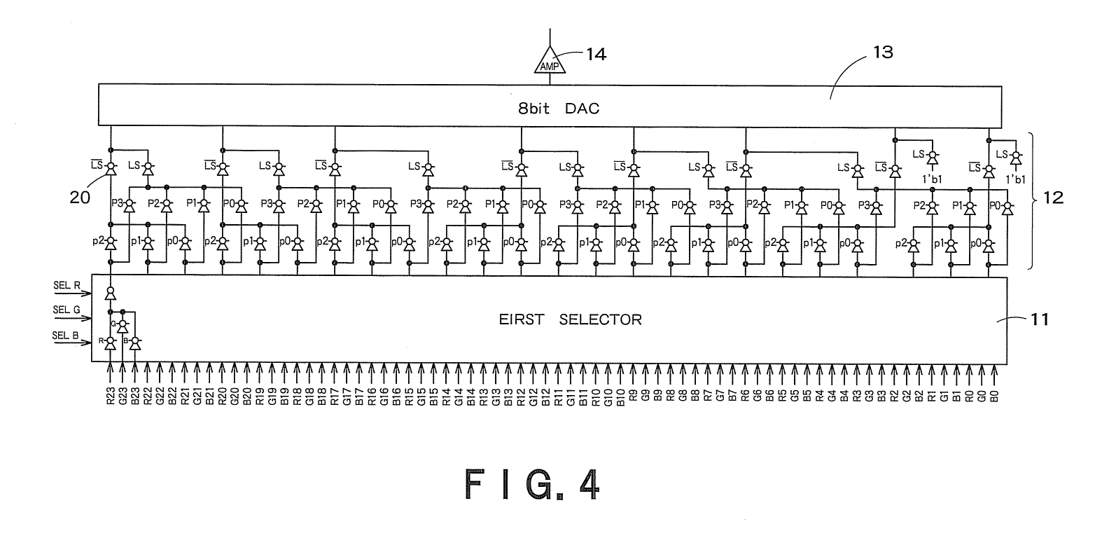

FIG. 4 is a circuit diagram showing one example of the internal configurations of the first selector 11 and the second selector 12. As shown, the first and second selectors 11, 12 are configured by use of a plurality of clocked inverters 20. A signal LS is a signal for selecting one of the vertically long display and the horizontally long display.

The first selector 11 selects the pixel data of a particular color in accordance with the logic of control signals SELR, SELG, SELB. Parallel data in which the RGB pixel data including 8 bits in each color are alternately arranged in order bit by bit is supplied from the RAM 6 to the first selector 11. The first selector 11 selects one of three most significant bits R23, G23, B23 of the RGB pixel data in accordance with the logic of the control signals SELR, SELG, SELB. Similar selecting operation is carried out for each bit of RGB. Such selecting operation for each bit is carried out in parallel.

Thus, the first selector 11 sorts the RGB pixel data bit by bit to select a color, so that it is desirable that the RGB pixel data for three pixels including 8 bits in each color be stored in the RAM 6 in the order of R23, G23, B23, . . . , R0, G0, B0.

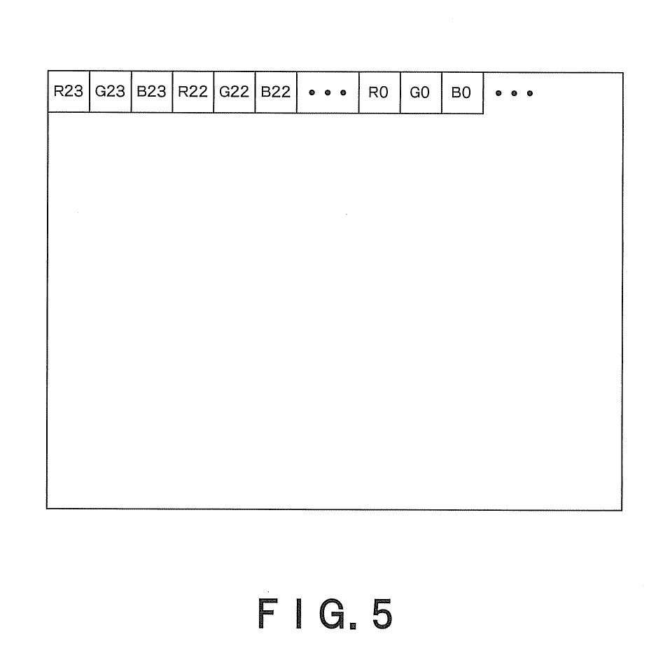

FIG. 5 is a diagram showing one example of a storage area of the RAM 6. As shown, the RGB pixel data is stored in the RAM 6 in the order of R23, G23, B23, . . . , R0, G0, B0, such that it is unnecessary to rearrange data at an input stage of the first selector 11, and it is also unnecessary to draw patterns around, allowing a reduction in the area of the circuits.

The second selector 12 selects pixel data of a particular pixel from the pixel data selected by the first selector 11, in accordance with the logic of control signals p0 to p2. More specifically, when the signal LS is low (in the case of the vertically long display), the second selector 12 selects pixel data of a particular pixel from three pixels in accordance with the logic of the control signals p0 to p2, and when the signal LS is high (in the case of the horizontally long display), the second selector 12 selects pixel data of a particular pixel from four pixels in accordance with the logic of control signals P0 to P3.

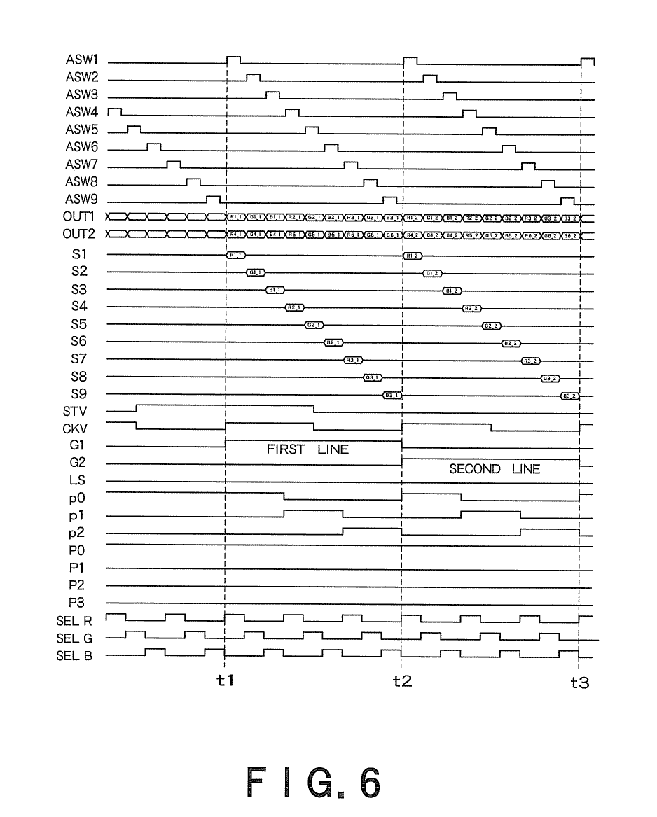

FIG. 6 is an operation timing diagram of the LCD driver 2 in FIG. 3. A period between times t1 and t2 is the display period of the first line, and a period between times t2 and t3 is the display period of the second line.

The control signals SELR, SEG, SELB for controlling the selecting operation of the first selector 11 repeat three times the operation of changing in three patterns between times t1 and t2, as shown in FIG. 6. Thus, RGB pixel data for three pixels are alternately selected three times for each color between times t1 and t2.

The control signals p0 to p2 for controlling the selecting operation of the second selector 12 change in three patterns between times t1 and t2, as shown in FIG. 6. Thus, the pixel data selected by the first selector 11 are alternately selected for each pixel between times t1 and t2.

Between times t1 and t2, the pixel voltage supply unit 10 at the left end in FIG. 3 sequentially outputs head pixels R1_1, G1_1, B1_1, and then sequentially outputs second pixels R2_1, G2_1, B2_1, and further sequentially outputs third pixels R3_1, G3_1, B3_1. In parallel with this, the second pixel voltage supply unit 10 from the left sequentially outputs fourth pixels R4_1, G4_1, B4_1, and then sequentially outputs fifth pixels R5_1, G5_1, B5_1, and further sequentially outputs sixth pixels R6_1, G6_1, B6_1.

Since control signals ASW1 to ASW9 for controlling the turning on/off of the analog switches 5 sequentially become high during the period between times t1 and t2, each of the analog switches 5 is sequentially turned on one time between times t1 and t2. Thus, between times t1 and t2, signal lines S1 to S9 are sequentially supplied with a total of nine analog pixel voltages R1_1, G1_1, B1_1, R2_1, G2_1, B2_1, R31, G3_1, B3_1 for three pixels.

Although the driving waveforms of the signal lines S1 to S9 driven by the pixel voltage supply unit 10 at the left end are only shown in FIG. 6, each of 80 pixel voltage supply units 10 in total drives nine signal lines between times t1 and t2, such that pixels for one horizontal line are displayed.

Then, between times t2 and t3, operation similar to that for the first line is performed for the RGB pixel data of the second line.

As described above, in the first embodiment, the second selector 12 is provided, which can switch the selecting operations at a time of driving the liquid crystal display for the vertically long display and at a time of driving the liquid crystal display for horizontally long display. The number of bits of the RGB pixel data stored in the RAM 6 is also switched at a time of driving the liquid crystal display for the vertically long display and at a time of driving the liquid crystal display for the horizontally long display. Therefore, the same LCD driver 2 can be used to drive the liquid crystal panels 1 of both types without changing the order of writing into the RAM 6 or reading from the RAM 6. Therefore, it is unnecessary to provide an LCD driver 2 special to the vertically long display or the horizontally long display, so that component costs can be reduced owing to shared components.

### SECOND EMBODIMENT

In a second embodiment, the same LCD driver 2 as that in the first embodiment is used to drive a liquid crystal panel 1 for horizontally long display.

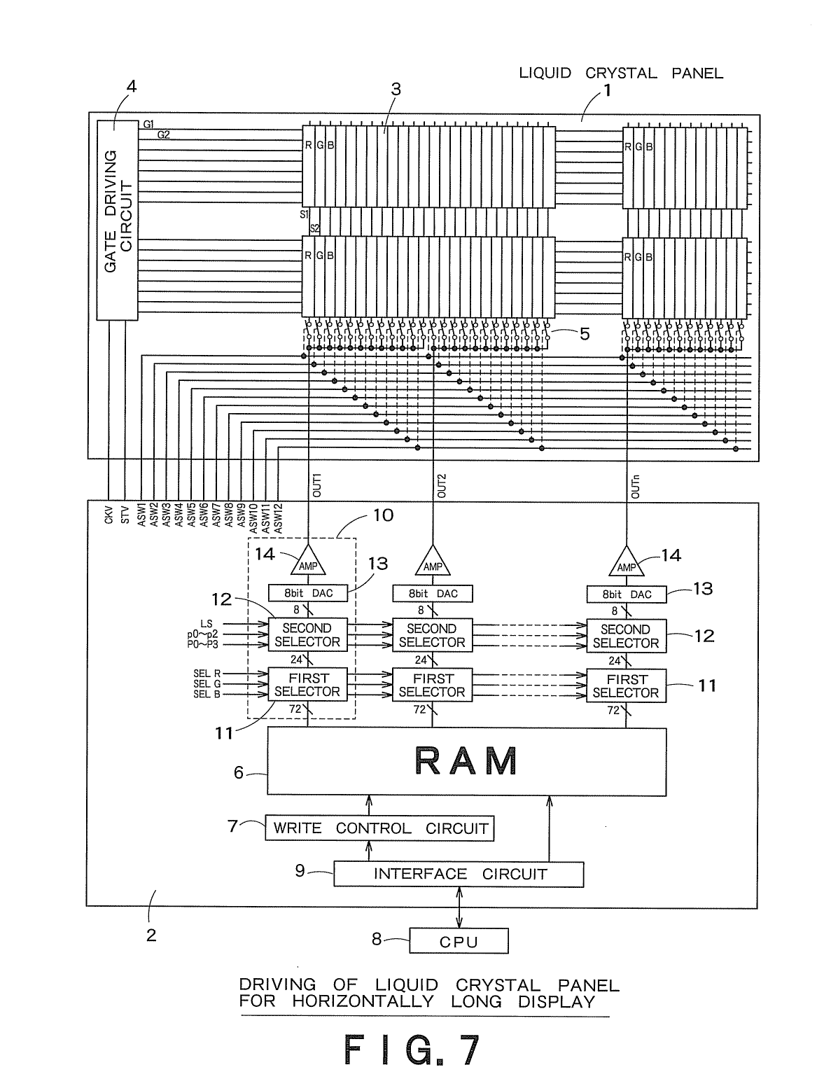

FIG. 7 is a block diagram showing a schematic configuration of a display device according to the second embodiment of the present invention. The LCD driver 2 in the display device in FIG. 7 is the same as the LCD driver 2 in FIG. 3, but is different therefrom in data stored in a RAM 6, in the operation of a second selector 12 and in the number of control signals for controlling analog switches 5 which are supplied from the LCD driver 2 to the liquid crystal panel 1.

In the example described in the first embodiment, RGB pixel data including 8 bits in each color is stored in the RAM 6 to drive the liquid crystal panel 1 for the vertically long display having a display resolution of vertical 320×horizontal 240 dots. In the present embodiment, however, RGB pixel data including 6 bits in each color is stored in the RAM 6 to drive the liquid crystal panel 1 of horizontal 320×vertical 240 dots.

The second selector 12 in FIG. 7 sequentially selects, pixel by pixel, pixel data of a particular color selected by a first selector 11, in accordance with the logic of control signals P0 to P3. The pixel data selected by the second selector 12 is converted into an analog pixel voltage in a D/A converter 13, and the gain of the analog pixel voltage is adjusted in an amplifier 14, and then the analog pixel voltage is supplied to the liquid crystal panel 1.

In accordance with the logic of a signal LS, the second selector 12 switches to select one pixel from three pixels for the vertically long display or to select one pixel from four pixels for the horizontally long display.

While nine analog switches 5 are connected to each of the pixel voltage supply units 10 in the LCD driver 2 in the liquid crystal panel 1 in FIG. 3, twelve analog switches 5 are connected to each of the pixel voltage supply units 10 in the liquid crystal panel 1 in FIG. 7. Therefore, the LCD driver 2 in FIG. 7 outputs control signals ASW1 to ASW12 for controlling the twelve analog switches 5.

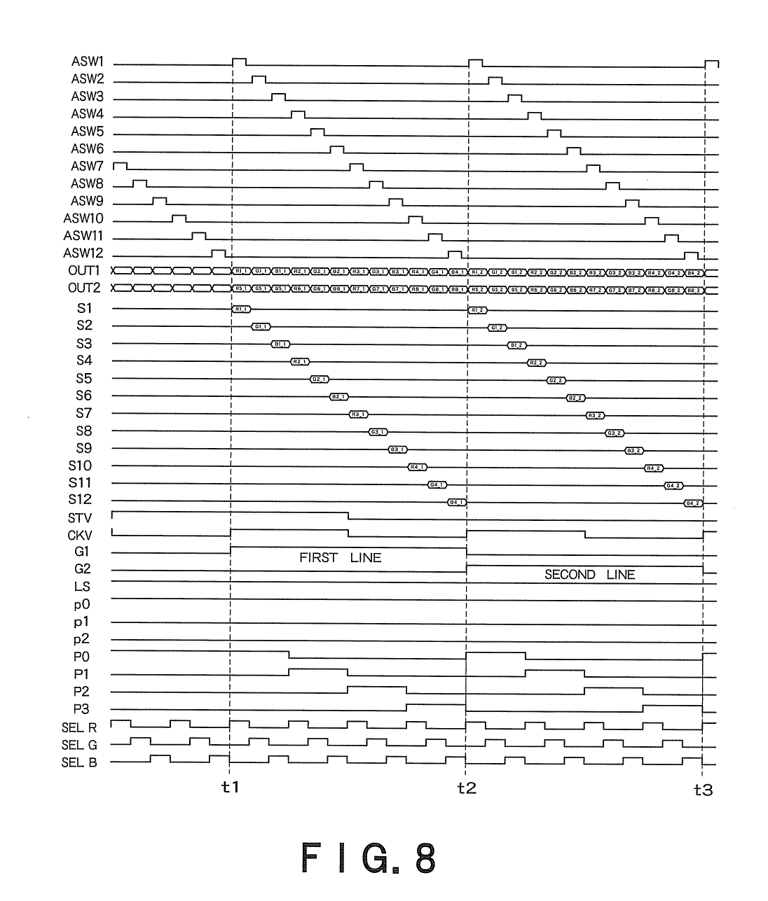

FIG. 8 is an operation timing diagram of the LCD driver 2 in FIG. 7. A period between times t1 and t2 is the display period of the first line, and a period between times t2 and t3 is the display period of the second line. Each of the pixel voltage supply units 10 in the LCD driver 2 outputs analog pixel voltages for four pixels during the period of one horizontal line (a total of twelve analog pixel voltages in RGB). These twelve analog pixel voltages are sequentially selected by the twelve analog switches 5, and then sequentially supplied to signal lines S1 to S12.

Thus, even when the liquid crystal panel 1 for horizontally long display is driven, the same LCD driver 2 as that in the first embodiment can be used. In this case, it is required only to change the number of bits in the pixel data to be stored in the RAM 6 and the logic of the signal LS to be input to the second selector 12.

While the analog pixel voltages for three pixels or four pixels are supplied from one pixel voltage supply unit 10 in the examples described in the first and second embodiments, the number of analog pixel voltages supplied by each pixel voltage supply unit 10 is not specifically limited. Moreover, the display resolution and horizontal to vertical pixel ratio of the liquid crystal panel 1 are not specifically limited either, but the present invention is effective when the horizontal to vertical pixel ratio is not 1:1.

What is claimed is:

1. A display control circuit, comprising:
a memory configured to store three-colors pixel data;
a first selector configured to select one color pixel data for m pixels in order among the three-colors pixel data for the m pixels read out from the memory when performing vertically long display in a display panel, where m is an integer of 1 or more, and to select one color pixel data for n pixels in order among the three-colors pixel data for the n pixels read out from the memory when performing horizontally long display in a display panel, where n is an integer of 1 or more, and different from m;
a second selector configured to select pixel data for one pixel in order among the pixel data for m pixels selected by the first selector when performing the vertically long display, and to select pixel data for one pixel in order among the pixel data for n pixels selected by the first selector when performing the horizontally long display;
a D/A converter configured to convert the pixel data selected by the second selector into an analog pixel voltage; and
a write controller configured to perform control for storing three-colors pixel data having the number of bits different between the vertically long display and the horizontally long display into the memory.

2. The display control circuit according to claim 1, wherein the write controller performs control for storing the three-colors pixel data into the memory so that the total number of bits of the three-colors pixel data for one horizontal line of the display panel when performing the vertically long display is equal to the total number of bits when performing the horizontally long display.

3. The display control circuit according to claim 1, wherein:
the total number of bits of the pixel data inputted to the first selector when performing the vertically long display is the same as the total number of bits when performing the horizontally long display;
the total number of bits of the pixel data inputted to the second selector when performing the vertically long display is the same as the total number of bits when performing the horizontally long display; and
the total number of bits of the pixel data outputted from the second selector when performing the vertically long display is not the same as the total number of bits when performing the horizontally long display.

4. The display control circuit according to claim 1, wherein:
the first selector selects m×3 times the three-colors pixel data alternately for each color when performing the vertically long display, and selects n×3 times when performing the horizontally long display, during one horizontal display period of the display panel; and
the second selector selects m times the pixel data selected by the first selector alternately for each pixel when performing the vertically long display, and selects n times when performing the horizontally long display, during one horizontal display period of the display panel.

5. The display control circuit according to claim 4, wherein:
the first selector outputs m times the pixel data of the same color for m pixels by each color during one horizontal display period of the display panel; and
the second selector outputs pixel data for one pixel among pixel data of the same color for m pixels outputted from the first selector.

6. The display control circuit according to claim 1, wherein the second selector includes:
a first signal terminal configured to input a signal for identifying either the vertically long display or the horizontally long display;
a second signal terminal configured to input a selection control signal for the vertically long display; and
a third signal terminal configured to input a selection control signal for the horizontally long display.

7. The display control circuit according to claim 6, wherein the signal inputted to the first signal terminal is a signal depending on the type of the display panel.

8. The display control circuit according to claim 1, wherein:
the write controller arranges the three-colors pixel data in units of bit alternately by each color in the memory; and
the first selector selects the three-colors pixel data read out from the memory in units of bit by each color in order.

9. The display control circuit according to claim 1, wherein:
the display panel is provided with a plurality of the first selectors, a plurality of the second selectors and a plurality of the D/A converters;
the plurality of first selectors perform selecting operation in parallel;
the plurality of second selectors perform selecting operation in parallel; and
the plurality of D/A converters perform converting operation in parallel.

10. The display control circuit according to claim 9, wherein the plurality of D/A converters output a plurality of analog pixel voltages corresponding to a plurality of pixels at the same timing by each interval of m pixels.

11. A display apparatus, comprising:
a display panel having a plurality of pixel switches which are provided to correspond to each cross point of signal lines and scanning lines arranged in matrix form; and
a display control circuit configured to generate analog pixel voltages supplied to the plurality of pixel switches,
wherein the display control circuit includes:
a memory configured to store three-colors pixel data;
a first selector configured to select one color pixel data for m pixels in order among the three-colors pixel data for the m pixels read out from the memory when performing vertically long display in a display panel, where m is an integer of 1 or more, and to select one color pixel data for n pixels in order among the three-colors pixel data for the n pixels read out from the memory when performing horizontally long display in a display panel, where n is an integer of 1 or more, and different from m;
a second selector configured to select pixel data for one pixel in order among the pixel data for m pixels selected by the first selector when performing the vertically long display, and to select pixel data for one pixel in order among the pixel data for n pixels selected by the first selector when performing the horizontally long display;
a D/A converter configured to convert the pixel data selected by the second selector into an analog pixel voltage; and
a write controller configured to perform control for storing three-colors pixel data having the number of bits different between the vertically long display and the horizontally long display into the memory.

12. The display apparatus according to claim 11, wherein the write controller performs control for storing the three-colors pixel data into the memory so that the total number of bits of the three-colors pixel data for one horizontal line of the display panel when performing the vertically long display is equal to the total number of bits when performing the horizontally long display.

13. The display apparatus according to claim 11, wherein:
the total number of bits of the pixel data inputted to the first selector when performing the vertically long display is the same as the total number of bits when performing the horizontally long display;
the total number of bits of the pixel data inputted to the second selector when performing the vertically long display is the same as the total number of bits when performing the horizontally long display; and
the total number of bits of the pixel data outputted from the second selector when performing the vertically long display is not the same as the total number of bits when performing the horizontally long display.

14. The display apparatus according to claim 11, wherein:
the first selector selects m×3 times the three-colors pixel data alternately for each color when performing the vertically long display, and selects n×3 times when performing the horizontally long display, during one horizontal display period of the display panel; and
the second selector selects m times the pixel data selected by the first selector alternately for each pixel when performing the vertically long display, and selects n times when performing the horizontally long display, during one horizontal display period of the display panel.

15. The display apparatus according to claim 14, wherein:
the first selector outputs m times the pixel data of the same color for m pixels by each color during one horizontal display period of the display panel; and
the second selector outputs pixel data for one pixel among pixel data of the same color for m pixels outputted from the first selector.

16. The display apparatus according to claim 11, wherein the second selector includes:
a first signal terminal configured to input a signal for identifying either the vertically long display or the horizontally long display;
a second signal terminal configured to input a selection control signal for the vertically long display; and
a third signal terminal configured to input a selection control signal for the horizontally long display.

17. The display apparatus according to claim 16, wherein the signal inputted to the first signal terminal is a signal depending on the type of the display panel.

18. The display apparatus according to claim 11, wherein:
the write controller arranges the three-colors pixel data in units of bit alternately by each color in the memory; and
the first selector selects the three-colors pixel data read out from the memory in units of bit by each color in order.

19. The display apparatus according to claim 11, wherein:
the display panel is provided with a plurality of the first selectors, a plurality of the second selectors and a plurality of the D/A converters;
the plurality of first selectors perform selecting operation in parallel;
the plurality of second selectors perform selecting operation in parallel; and
the plurality of D/A converters perform converting operation in parallel.

20. The display apparatus according to claim 19, wherein the plurality of D/A converters output a plurality of analog pixel voltages corresponding to a plurality of pixels at the same timing by each interval of m pixels.
